(19) United States
(12) Patent Application Publication
(10) Pub. No.: US 2026/0153893 A1
(43) Pub. Date: Jun. 4, 2026

(54) BANDGAP REFERENCE CIRCUIT

(71) Applicant: NXP B.V., Eindhoven (NL)

(72) Inventor: Arvind Sherigar, Bangalore (IN)

(21) Appl. No.: 19/383,354

(22) Filed: Nov. 7, 2025

(30) Foreign Application Priority Data
Nov. 11, 2024 (IN) 202441086752

(51) Int. Cl. G05F 3/26

(52) U.S. Cl. CPC G05F 3/262

(57) ABSTRACT

A bandgap reference circuit comprising: a proportional to absolute temperature, PTAT, voltage circuit configured to generate a PTAT voltage; and a bandgap voltage circuit comprising a diode, the bandgap voltage circuit configured to: receive the PTAT voltage from the PTAT voltage circuit; and combine the PTAT voltage with a diode voltage across the diode to output a bandgap reference voltage.

### CROSS-REFERENCE TO RELATED APPLICATIONS

This application claims the priority under 35 U.S.C. § 119 of India patent application Ser. No. 202441086752, filed Nov. 11, 2024, the contents of which are incorporated by reference herein.

### FIELD

The present disclosure relates to a bandgap reference circuit.

### SUMMARY

According to a first aspect of the present disclosure there is provided a bandgap reference circuit comprising: a proportional to absolute temperature, PTAT, voltage circuit configured to generate a PTAT voltage; and a bandgap voltage circuit comprising a diode, the bandgap voltage circuit configured to: receive the PTAT voltage from the PTAT voltage circuit; and combine the PTAT voltage with a diode voltage across the diode to output a bandgap reference voltage.

In one or more embodiments, the bandgap voltage circuit may comprise: a bandgap voltage node configured to output the bandgap reference voltage; and a tail voltage node configured to be set to the PTAT voltage, wherein an anode of the diode is connected to the bandgap voltage node and a cathode of the diode is connected to the tail voltage node.

In one or more embodiments, the bandgap voltage circuit may comprise: a regulating transistor with a source terminal coupled to a supply voltage node and a drain terminal connected to the bandgap voltage node; an input circuit coupled to the PTAT voltage circuit and configured to set the tail voltage node to the PTAT voltage; and a current mirror output transistor with a conduction channel connected between the tail voltage node and a reference voltage node.

In one or more embodiments, the PTAT voltage circuit is configured to generate the PTAT voltage from a supply voltage received at the supply voltage node.

In one or more embodiments, the input circuit may comprise: a first input transistor, wherein a source terminal of the first input transistor is connected to the supply node and a drain terminal of the first input transistor is connected to a gate terminal of the regulating transistor; and a second input transistor, wherein a drain terminal of the second input transistor is connected to the gate terminal of the regulating transistor and a source terminal of the second input transistor is connected to the tail voltage node.

The first and second input transistor may form an output of a current mirror. The input circuit may mirror a PTAT current from the PTAT voltage circuit. The input circuit may mirror the PTAT voltage from the PTAT voltage circuit to the tail voltage node. A gate terminal of each of the first and second input transistors may be connected to a respective terminal of the PTAT voltage circuit.

The regulating transistor, the diode and the first and second input transistors may form a regulation loop. The regulation loop may regulate a current through the regulating transistor to regulate the bandgap reference voltage at the bandgap voltage node. The regulation loop may regulate the bandgap reference voltage to the sum of the PTAT voltage and the diode voltage.

In one or more embodiments, the bandgap reference circuit may comprise an output circuit connected between the bandgap voltage node and a reference node, wherein the output circuit is configured to provide a constant current through the output circuit from the bandgap voltage node to the reference node.

In one or more embodiments, the output circuit may comprise an output resistance circuit.

The output resistance circuit may comprise a plurality of resistors.

In one or more embodiments, wherein the output circuit may comprise a current sink.

In one or more embodiments, the current mirror output transistor may be configured to pull a constant current through the regulating transistor that is equal to the constant current provided through the output circuit.

The current mirror output transistor is configured to mirror a multiple of a PTAT current from the PTAT voltage circuit to provide the constant current through the regulating transistor.

In one or more embodiments, the bandgap reference circuit may comprise an output current reference transistor configured to mirror the constant current from the regulating transistor to a constant current output terminal.

In one or more embodiments, the bandgap reference circuit may comprise a balancing current transistor, wherein: a source terminal of the balancing current transistor is connected to the supply voltage node; and a drain terminal of the balancing current transistor is connected to the bandgap voltage node.

The balancing current transistor may mirror a PTAT current from the PTAT voltage circuit. A gate terminal of the balancing current transistor may be coupled to the PTAT voltage circuit.

In one or more embodiments: the input circuit may be configured to mirror a first PTAT current from the PTAT voltage circuit; the balancing current transistor is configured to mirror a second PTAT current from the PTAT voltage circuit; and the current mirror output transistor is configured to mirror a third PTAT current from the PTAT voltage circuit equal to a sum of the first PTAT current and the second PTAT current.

In one or more embodiments, the first PTAT current may equal the second PTAT current.

The balancing current transistor may mirror the second PTAT current by mirroring the first PTAT current from the input circuit.

In one or more embodiments, the PTAT voltage circuit may comprise: a PTAT core comprising a first resistor and configured to generate a PTAT current through the first resistor; and an intermediate current mirror branch comprising a second resistor and configured to mirror the PTAT current from the PTAT core through the second resistor to generate the PTAT voltage.

In one or more embodiments, a resistance of the second resistor may be greater than a resistance of the first resistor.

According to a second aspect of the present disclosure, there is provided an automotive transceiver comprising the bandgap reference circuit of any preceding claim.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future Claim sets. The figures and Detailed Description that follow also exemplify various example embodiments. Various example embodiments may be more completely understood in consideration of the following Detailed Description in connection with the accompanying Drawings.

### BRIEF DESCRIPTION OF THE DRAWINGS

One or more embodiments will now be described by way of example only with reference to the accompanying drawings in which:

FIG. 1 shows an example embodiment of a bandgap reference circuit according to an embodiment of the present disclosure;

FIG. 2A illustrates the temperature variation of a bandgap reference circuit according to an embodiment of the present disclosure;

FIG. 2B illustrates further temperature dependencies of a bandgap reference circuit according to an embodiment of the present disclosure;

FIG. 2C illustrates the noise performance of a bandgap reference circuit according to an embodiment of the present disclosure;

FIG. 2D illustrates simulated manufacturing variability of a bandgap reference voltage of a bandgap reference circuit according to an embodiment of the present disclosure;

FIG. 2E illustrates simulated manufacturing variability of a quiescent current of a bandgap reference circuit according to an embodiment of the present disclosure;

FIG. 2F illustrates the supply voltage EMI tolerance of a bandgap reference circuit according to an embodiment of the present disclosure;

FIG. 2G illustrates handle wafer EMI tolerance of a bandgap reference circuit according to an embodiment of the present disclosure; and

FIG. 2H illustrates ground node EMI tolerance of a bandgap reference circuit according to an embodiment of the present disclosure.

### DETAILED DESCRIPTION

A bandgap reference circuit built with bipolar transistors is generally used in a Brokaw or Banba configuration to build a bandgap reference voltage. Bipolar transistors are known to create electromagnetic interference (EMI) issues since the collector is exposed to the substrate/handle wafer. To avoid bipolars, simple PN diodes are typically used in a Banba architecture to achieve a constant reference voltage/current. However, using PN didoes in a Banba architecture results in high area and high noise.

The present disclosure provides a bandgap reference circuit that can result in lower area and lower current consumption relative to a PN diode Banba architecture while achieving the same or improved accuracy and noise performance. An issue with reducing both current consumption and area in Banba circuits is that the two factors work against each other. Reducing current consumption results in larger resistors. Reducing the resistor size results in less accurate reference voltages.

The present disclosure devises a new Bandgap reference architecture that uses less area and generates low noise compared to a Banba architecture.

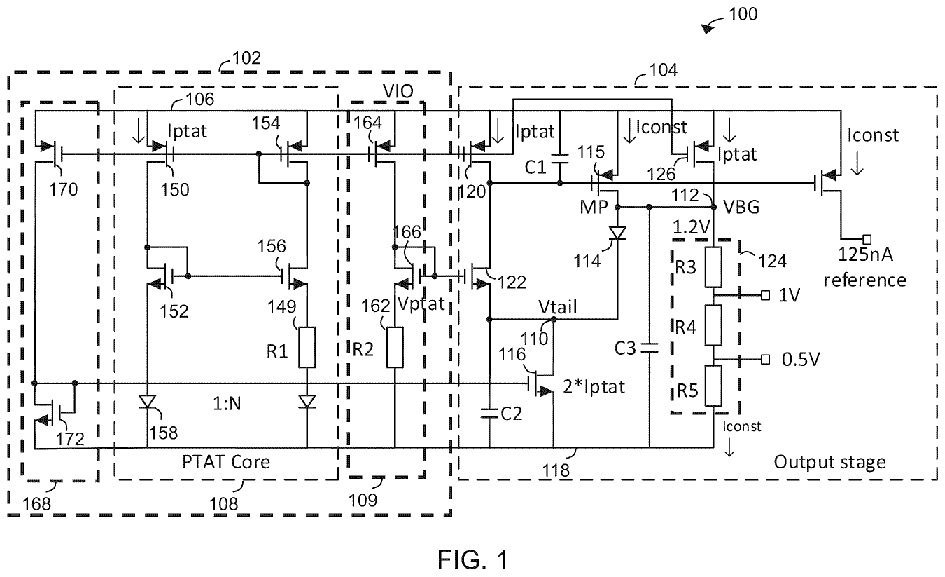

FIG. 1 illustrates a bandgap reference circuit 100 according to an embodiment of the present disclosure. The band gap reference circuit 100 comprises a proportional to absolute temperature (PTAT) voltage circuit 102 and a bandgap voltage circuit 104. The bandgap reference circuit 104 comprises a diode 114. The bandgap reference circuit 104 is configured to receive a PTAT voltage, Vptat, from the PTAT voltage circuit 102 and combine (e.g. sum) the PTAT voltage, Vptat, with a diode voltage, across the diode 114, to generate a bandgap reference voltage, VBG.

As the diode voltage is complementary to absolute temperature (CTAT) the resulting bandgap reference voltage, VBG, advantageously provides a fixed, substantially temperature-independent voltage reference. The addition of PTAT and CTAT components results in a temperature independent voltage with the typical bandgap curvature.

In this example, the PTAT voltage circuit 102 is configured to generate a PTAT voltage, Vptat, from a supply voltage, VIO, received at a supply voltage node 106. The PTAT voltage circuit 102 may comprise a PTAT core 108 configured to generate a PTAT current, Iptat. The PTAT voltage circuit 102 may comprise an intermediate leg to mirror the PTAT current, Iptat, from the PTAT core 108 and generate the PTAT voltage, Vptat, for providing to the bandgap voltage circuit 104. The example PTAT voltage circuit 102 is described in more detail below.

In this example, the bandgap voltage circuit 104 comprises a tail voltage node, Vtail, 110. The tail voltage node 110 can be set to the PTAT voltage, Vptat, received from the PTAT voltage circuit 102. The bandgap voltage circuit 104 also comprises a bandgap voltage node 112 configured to output the bandgap reference voltage, VBG. An anode of the diode 114 is connected to the bandgap voltage node 112 and a cathode of the diode 114 is connected to the tail voltage node 110.

In this example, the bandgap voltage circuit 104 includes a regulating transistor 115 (labelled MP in the figure) with a source node coupled to the supply voltage node 106 and a drain node coupled to the bandgap voltage node 112. In this example, the regulating transistor 115 is a PMOS transistor. The bandgap voltage circuit 104 also includes a current mirror output transistor 116 with a conduction channel connected between the tail voltage node 110 and a reference voltage node 118 (which may also be referred to as a ground voltage node). The reference voltage node 118 may be coupled to a reference voltage such as ground. In this example, the current mirror output transistor 116 is a NMOS transistor.

The bandgap voltage circuit 104 also includes an input circuit configured to set the tail voltage node to the PTAT voltage, Vptat. In this example, the input circuit includes a first input transistor 120 and a second input transistor 122. A source terminal of the first input transistor 120 is connected to the supply voltage node 106 and a drain terminal of the first input transistor is connected to a gate terminal of the regulating transistor 115. In this example, the first input transistor 120 comprises a PMOS transistor. A drain terminal of the second input transistor 122 is connected to the gate terminal of the regulating transistor 115 and a source terminal of the second input transistor 122 is connected to the tail voltage node 110. The input circuit comprising the first and second input transistors 120, 122 form the output of a current mirror. The gate terminal of each of the first and second input transistors 120, 122 is connected to a respective terminal of the PTAT voltage circuit 102. The current mirror can mirror the PTAT current, Iptat, from the PTAT voltage circuit 102 through the conduction channels of the first and second input transistors 120, 122 and thereby mirror the PTAT voltage, Vptat, to the tail voltage node 110.

The regulating transistor 115, the diode 114, and the first and second input transistors 120, 122 can form a regulation loop. The regulation loop regulates a current through the regulating transistor 115 to regulate the bandgap reference voltage, VBG, at the bandgap voltage node 112 to the sum of the PTAT voltage, Vptat, and the diode voltage. The regulation loop is similar to a flipped voltage follower (FVF) loop and comprises a low-dropout (LDO) regulator structure that sums the PTAT voltage, Vptat, with the diode voltage in one stage. The regulation loop has high loop gain ensures good regulation across line and load changes—the bandgap reference voltage, VBG, is independent of supply or load changes.

The bandgap voltage circuit may comprise an output circuit connected between the bandgap voltage node 112 and the reference node 118. In this example, the output circuit comprises an output resistance circuit 124 connected between the bandgap voltage node 112 and the reference node 118. In this example, the output resistance circuit includes a plurality of output resistors, labelled R3, R4 & R5 in the figure. In this way, nodes between each pair of output resistors can each provide an intermediate reference voltage less than the bandgap reference voltage, VBG, depending on the relative resistance values of the output resistors. In this example, the bandgap reference voltage, VBG, is 1.2 V and three output resistors provide additional temperature-independent intermediate reference voltages of 1V and 0.5V.

As the bandgap reference voltage, VBG, has a fixed or constant value, connecting the output resistance circuit 124 between the bandgap voltage node 112 and the reference node 118 will result in a constant current, Iconst, flowing through the output resistance circuit during operation. The constant current, Iconst, will be equal to the bandgap reference voltage, VBG, divided by the resistance of the output resistance circuit 124 (VBG/(R3+R4+R5). As a result, the intermediate voltages will be fixed and temperature independent.

In other examples, the output circuit may comprise a current sink instead of the output resistance circuit 124. The current sink may provide a constant current flow through the output circuit from the bandgap voltage node 112 to the reference node.

As discussed below, the current mirror output transistor 116 may be dimensioned such that it is configured to pull a constant current through the regulating transistor that is equal to the constant current provided through the output circuit.

In this example, the bandgap voltage circuit 104 includes a balancing current transistor 126. A source terminal of the balancing current transistor 126 is connected to the supply voltage node and a drain terminal of the balancing current transistor 126 is connected to the bandgap voltage node 112. A gate of the balancing current transistor 126 is coupled to the PTAT voltage circuit 102 to mirror the PTAT current, Iptat, through the balancing current transistor 126. In this example, the gate of the balancing current transistor 126 is connected to a gate of the first input transistor 120 to mirror the PTAT current, Iptat. In this example, the balancing current transistor 126 is a PMOS transistor.

As noted above, the current mirror output transistor is dimensioned such that the current through the regulating transistor 115 matches the current though the output circuit. In some examples, the current mirror output transistor 116 may be configured to mirror a multiple of the PTAT current, Iptat, from the PTAT voltage circuit 102. The current mirror output transistor is sized to mirror a multiple of the PTAT current, Iptat, equal to the sum of: (i) the PTAT current, Iptat, configured to flow through the input circuit (first and second input transistors 120, 122); and (ii) the PTAT current, Iptat, configured to flow through the balancing current transistor 126. Said another way: the input circuit is configured to mirror a first PTAT current, Iptat, from the PTAT voltage circuit 102; the balancing current transistor 126 is configured to mirror a second PTAT current, Iptat, from the PTAT voltage circuit 102; and the current mirror output transistor 116 is configured to mirror a third PTAT current, 2*Iptat, from the PTAT voltage circuit 102 equal to a sum of the first PTAT current, Iptat, and the second PTAT current, Iptat.

In this example, the current mirror output transistor 116 is configured to mirror two times the PTAT current, 2*Iptat, from the PTAT voltage circuit 102 corresponding to the sum of Iptat configured to flow through the first and second input transistors 120, 122 and Iptat configured to flow through the balancing current transistor. In other words, the first PTAT current equals the second PTAT current. As a result of Kirchoff's current laws (sum of currents into and out of a node are equal): (i) the PTAT current, Iptat, will flow through the diode 114; and (ii) the regulation loop will adjust current through regulating transistor 115 to equal the constant current, Iconst. Taking each of these in turn:

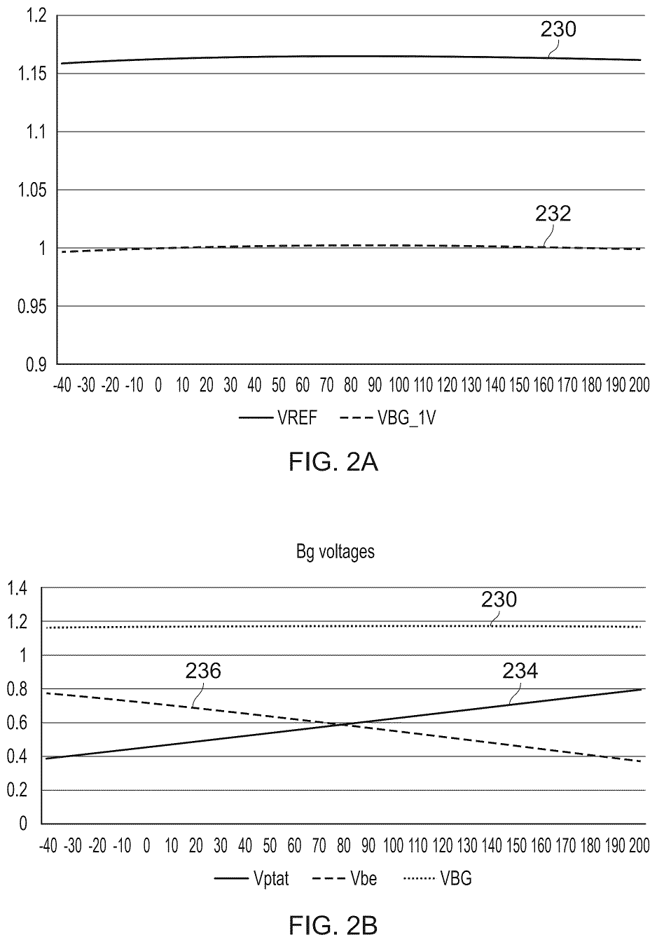

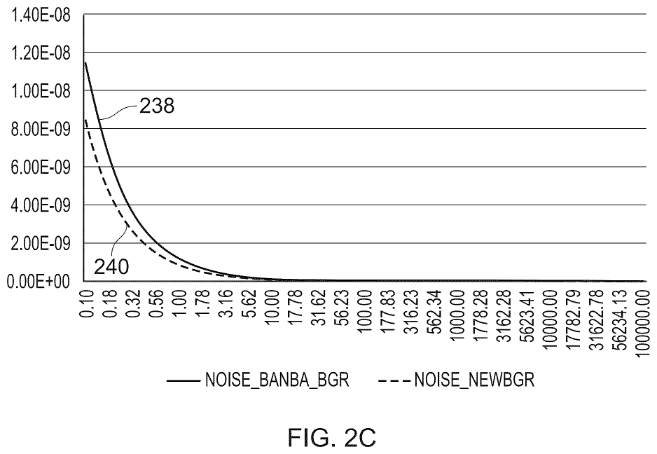

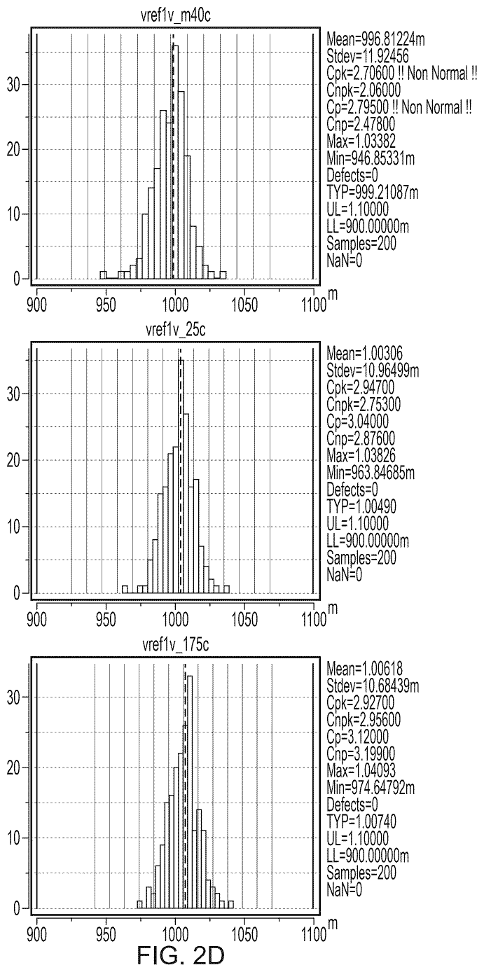

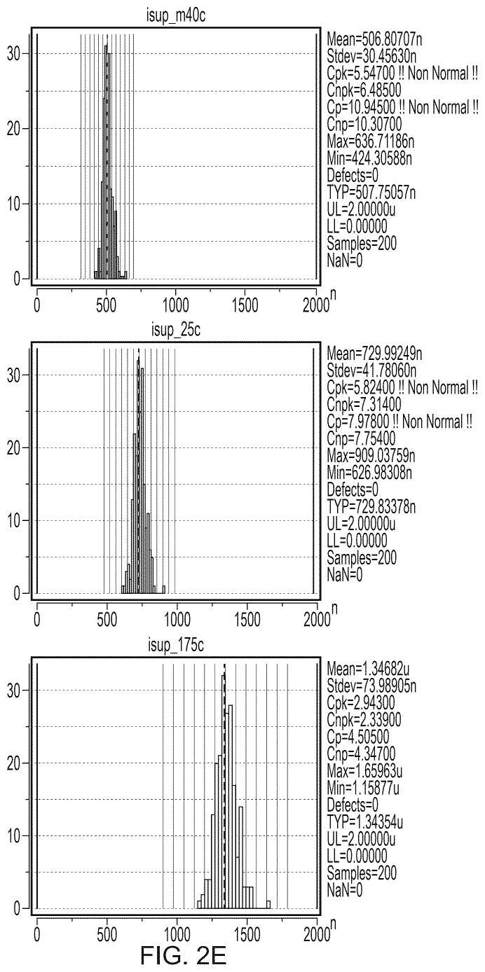

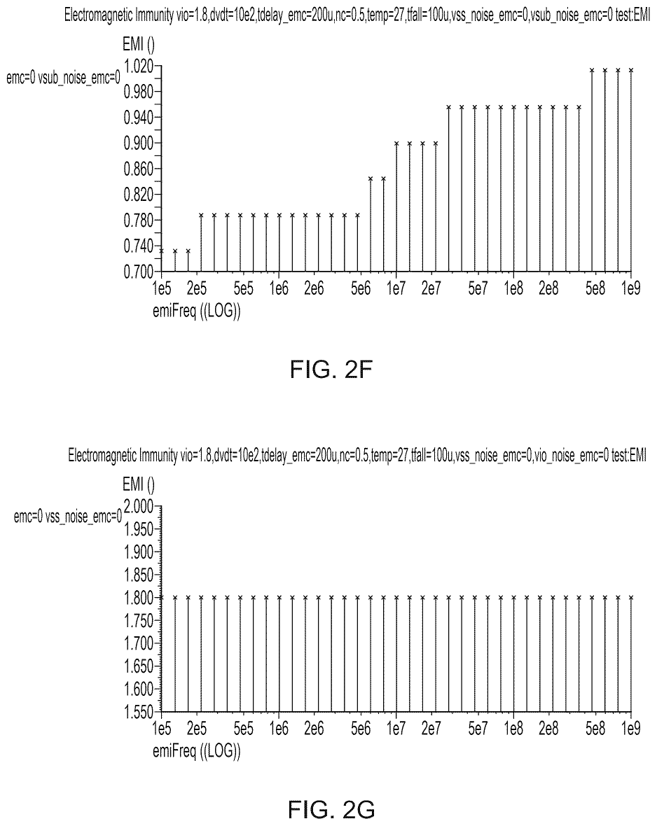

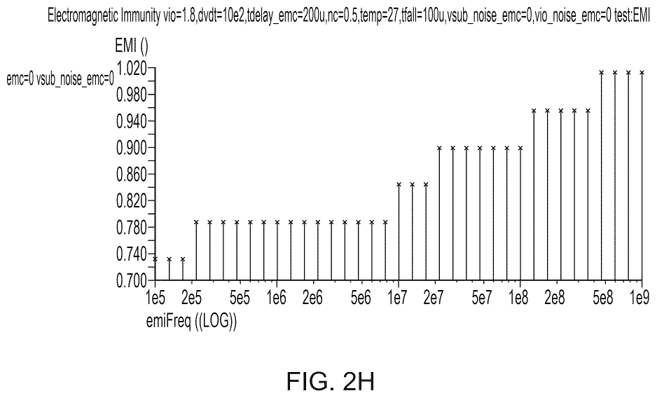

Providing the PTAT current, Iptat, through the diode will result in a CTAT diode voltage that better complements the PTAT voltage, Vptat, and provides a more constant bandgap reference voltage, VBG. This is because the diode voltage dependence on temperature is non-linear (see FIG. 2B).

The constant current, Iconst, through the regulating transistor 115 can be mirrored to provide a constant current output. In this example, the bandgap voltage circuit 104 includes an output current reference transistor 128 configured to mirror the constant current, Iconst, flowing through the regulating transistor 115. In this example, the constant current, Iconst, is 125 nA. In this way, the bandgap reference circuit 100 has the ability to advantageously output any of:
A constant voltage—the bandgap reference voltage, VBG;
A constant current, Iconst;
A PTAT current, Iptat;
A PTAT voltage, Vptat; and
A CTAT current.

The bandgap reference circuit 100 may include a simple current mirror subtraction circuit (not shown) to output the CTAT current (Iconst−Iptat).

Some example bandgap voltage circuits 104 may not include the current balancing transistor 126. As a result: (i) the current mirror output transistor 116 will mirror (one times) the PTAT current, Iptat, from the PTAT voltage circuit 102; and (ii) the current through the diode will be zero. Such a circuit will still provide a temperature-independent bandgap reference voltage, VBG, a constant current through the resistor circuit 124 and a constant current through the regulating transistor 115. However, the temperature independence of the constant current, Iconst, and bandgap reference voltage, VBG, may be less optimal than examples including the current balancing transistor 126.

In some examples, the bandgap voltage circuit may include a current sink instead of the resistor circuit 124. A current sink approach may be particularly useful for some applications such as when the bandgap reference circuit is provided to a digital to analog converter (DAC).

In this example, the bandgap voltage circuit 104 includes a first capacitor, C1, connected between the supply node 106 and the gate terminal of the regulating transistor 115. The first capacitor improves stability of the regulating loop.

In this example, the bandgap voltage circuit 104 includes a second capacitor, C2, connected in parallel with the current mirror output transistor 116 and a third capacitor, C3, connected in parallel with the output resistance circuit 124. The second and third capacitors can improve noise/EMI performance.

Turning to the PTAT voltage circuit 102, in this example, the PTAT voltage circuit 102 includes a PTAT core 108 and an intermediate current mirror branch 109.

The PTAT core 108 generates the PTAT current, Iptat, using a first resistor 149, with resistance R1. PTAT core circuits are well known and a brief description of the operation of the PTAT core circuit is included here for completeness.

The PTAT core 108 includes a current mirror comprising: a first PTAT core transistor 150; a second PTAT core transistor 152; a third PTAT core transistor 154; and a fourth PTAT core transistor 156. The first to fourth PTAT core transistors are arranged in a conventional current mirror arrangement. In this example, the first and third PTAT core transistors 150, 154 are PMOS transistors and the second and fourth PTAT core transistors 152, 156 are NMOS transistors. Gate terminals of the first and third PTAT core transistors 150, 154 are connected together. Gate terminals of the second and fourth PTAT core transistors 152, 156 are connected together. The gate terminal of the second PTAT core transistor 152 is connected to a drain terminal of the second PTAT core transistor 152. The gate terminal of the third PTAT core transistor 154 is connected to a drain terminal of the third PTAT core transistor 154.

The first PTAT core transistor 150 has a source terminal coupled to the supply voltage node 106 and a drain terminal coupled to the drain terminal of the second PTAT core transistor 152. The source terminal of the second PTAT core transistor 152 is connected to an anode of a first PTAT core diode 158. A cathode of the first PTAT core diode 158 is coupled to the reference node 118.

The third PTAT core transistor 154 has a source terminal coupled to the supply voltage node 106 and a drain terminal coupled to a drain terminal of the fourth PTAT core transistor 156. The source terminal of the fourth PTAT core transistor 152 is connected to a first terminal of the first resistor 149. A second terminal of the first resistor 149 is connected to an anode of a second PTAT core diode 160. A cathode of the second PTAT core diode 160 is coupled to the reference node 118. The second PTAT core diode 160 is N times larger than the first PTAT core diode 158.

The first and second PTAT core transistors 150, 152 and the first PTAT core diode 158 may define a first branch of the PTAT core 108. The second and fourth PTAT core transistors 154, 156, the first resistor 149 and the second PTAT core diode 160 may define a second branch of the PTAT core 108.

Each of the first to fourth PTAT core transistors, 150, 152, 154, 156 are the same size such that the current mirror generates the same PTAT current, Iptat, in each branch. The same voltage is also provided at the source terminals of the second and fourth PTAT core transistors 152, 156.

In more detail, the voltage, Vbe1, across the first PTAT core diode 158 can be written as:

$$Vbe 1 = {V}_{T} ln ( \frac{{I}_{ptat}}{{I}_{s}} )$$

where V_{T} is the thermal voltage and Iₛ is the saturation current.

The voltage, Vbe2, across the second PTAT core diode 160 can be written as:

$$Vbe 2 = {V}_{T} ln ( \frac{{I}_{ptat}}{N \cdot {I}_{s}} )$$

The difference between Vbe1 and Vbe2 provides the voltage across the first resistor 149:

$$Vbe 1 - Vbe 2 = \frac{KT}{q} ln ( N )$$

where K is Boltzmann's constant and q is the electron charge. The voltage drop across the first resistor 149 is proportional to temperature and this generates the PTAT current, Iptat, in the PTAT core 108.

The intermediate current mirror branch 109 mirrors the PTAT current, Iptat, from the PTAT core 108 through a second resistor 162, with resistance R2, to generate the PTAT voltage, Vptat. A magnitude of the PTAT voltage, Vptat, depends on the ratio of the resistance, R2, of the second resistor 162 to the resistance, R1, of the first resistor 149. The PTAT voltage, Vptat, can be written as:

$$Vptat = \frac{R 2}{R 1} \cdot \frac{KT}{q} ln ( N )$$

In some examples, the resistance R2 is greater than the resistance R1, such that the PTAT voltage, Vptat, is larger than the PTAT voltage across the first resistor 149.

The intermediate current mirror branch 109 and the input circuit of the bandgap voltage circuit 104 can form a current mirror. The intermediate current mirror branch 109 and the input circuit can mirror the PTAT current, Iptat, to the input circuit and thereby set the tail voltage node 110 to the PTAT voltage, Vptat.

In this example, the intermediate current mirror branch 109 comprises a first intermediate transistor 164, a second intermediate transistor 166 and the second resistor 162. The first intermediate transistor 164 is a PMOS transistor and the second intermediate transistor 166 is a NMOS transistor. A source terminal of the first intermediate transistor 164 is connected to the supply voltage node 106 and a drain terminal of the first intermediate transistor 164 is coupled to a drain terminal of the second intermediate transistor 166. A source terminal of the second intermediate transistor 166 is connected to a first terminal of the second resistor 162 and a second terminal of the second resistor 162 is connected to the reference node 118. A gate terminal of the first intermediate transistor 164 is to the gate terminal of the third PTAT core transistor 154. The gate terminal of the first intermediate transistor 164 is also connected to the gate terminal of the first input transistor 120. A gate terminal of the second intermediate transistor is connected to the gate terminal of the second input transistor 122 and to the drain terminal of the second intermediate transistor 166.

In this example, the PTAT voltage circuit 102 comprises a further current mirror branch 168. The further current mirror branch 168 is configured to mirror the PTAT current, Iptat, to the current mirror output transistor 116 of the bandgap voltage circuit 104. As noted above, the current mirror output transistor 116 may be scaled such that the current mirror output transistor 116 mirrors a multiple of the PTAT current, Iptat, in this example 2*Iptat.

The further current mirror branch 168 includes a first further transistor 170 and a second further transistor 172. In this example, the first further transistor 170 is a PMOS transistor and the second further transistor 172 is a NMOS transistor. A source terminal of the first further transistor 170 is connected to the supply voltage node 106 and a drain terminal of the first further transistor 170 is connected to a drain terminal of the second further transistor 172. A source terminal of the second further transistor 172 is connected to the reference node 118. A gate terminal of the second further transistor 172 is connected to the drain terminal of the second further transistor 172 and a gate terminal of the current mirror output transistor 116. A gate terminal of the first further transistor 170 is connected to the gate terminal of the first PTAT core transistor 150.

In the example of FIG. 1, the gate terminals of each of the first PTAT core transistor 150, the third PTAT core transistor 154, the first intermediate transistor 164, the first further transistor 170, the first input transistor 120 and the current balancing transistor 126 are connected together. In this way, the PTAT current, Iptat, is configured to flow through each respective branch of the bandgap reference circuit 100.

In the bandgap reference circuit, trimming of the bandgap reference voltage, VBG, can be implemented by changing the resistance value ratio R2 R1. Trimming of the intermediate reference voltages can also be achieved by adjusting the resistance values of the output resistors.

In some examples, all transistors of the bandgap reference circuit may have the same switch on voltage. For example, all transistors have the same gate-source voltage. In some examples, all transistors may have a gate source voltage of 1.5V or 1.3 V. In this way, the bandgap reference circuit can operate at voltages as low as 1.5V or 1.3V accordingly.

In summary, the bandgap reference circuit comprises:

A PTAT core 108 to generate a PTAT current, Iptat, which is mirrored to a second resistor 162 to generate a PTAT voltage, Vptat.

The PTAT voltage, Vptat, is mirrored into a bandgap voltage circuit 104 and added with a diode voltage to generate the bandgap reference voltage, VBG.

The bandgap reference circuit 100 can output separate PTAT and CTAT currents for usage in other circuits.

As discussed below, this unique scheme consumes less current and area than a Banba configuration and produces overall low noise.

FIGS. 2A to 2H illustrate the simulated performance of a bandgap reference circuit according to an embodiment of the present disclosure.

FIG. 2A includes a first plot 230 illustrating the variation of the bandgap reference voltage with temperature and a second plot 232 illustrating the variation of the intermediate reference voltage at 1V with temperature. A typical bandgap performance is seen.

FIG. 2B illustrates the same plot 230 of the bandgap reference voltage variation with temperature along with a second plot 234 illustrating the PTAT voltage, Vptat, variation with temperature and a third plot 236 illustrating the CTAT diode voltage, Vbe, variation with temperature. The bandgap reference voltage is equal to the sum of the PTAT voltage, Vptat, and the CTAT diode voltage, Vbe.

FIG. 2C illustrates the noise performance of the bandgap reference circuit. A first plot 238 illustrates the noise performance as a function of frequency for a typical Banba architecture. A second plot 240 illustrates the noise performance as a function of frequency for a bandgap reference circuit according to an embodiment of the present disclosure. The noise is higher at low frequencies due to the presence of flicker noise. However, the bandgap reference circuit of the present disclosure has ˜20% lower flicker noise. This is because the bandgap reference circuits of the present disclosure do not include an operational transconductance amplifier (OTA), unlike the Banba architecture. Although not visible in the plot, the noise performance of the bandgap reference circuit is also better than the Banba architecture at high frequencies, and the total integrated noise between 100 mHz and 1 MHz is substantially lower by a factor of 5.

FIG. 2D illustrates Montecarlo simulations of a distribution of bandgap reference voltages at three different temperatures (−40° C., 25° C. and 175° C.) for a simulation of typical manufacturing variations of bandgap reference circuits according to the present disclosure. The spread in voltages (stdev˜11 mV) is similar in performance to the Banba architecture. The bandgap reference circuits according to the present disclosure have a reduced area compared to a typical Banba bandgap circuit by around 20%. This is because the total rpoly resistor area is smaller. FIG. 2D illustrates that the lower area does not result in a degradation of performance relative to the Banba architecture.

FIG. 2E illustrates Montecarlo simulations of a distribution of the quiescent current, Iq, at three different temperatures (−40° C., 25° C. and 175° C.) for a simulation of typical manufacturing variations of bandgap reference circuits according to the present disclosure. The central plot illustrates a quiescent current consumption of 730 nA which is over a factor of 2 less than the typical Banba current consumption of 1.6-1.7 uA.

A usual concern in automotive CAN/10BaseT1s transceiver systems is that the bandgap reference circuit has to be low current, low area and has to be EMI tolerant. FIGS. 2F to 2I illustrate that bandgap reference circuits perform well in EMI simulations.

FIG. 2F illustrates tolerance of the bandgap reference circuit to EMI noise at the supply voltage node. Each plot illustrates the maximum EMI tolerance at a range of different frequency values of the EMI noise. The peak to peak tolerance is double the values illustrated. At high frequencies, the peak to peak EMI tolerance at the supply voltage node is over 2V.

FIG. 2G illustrates tolerance of the bandgap reference circuit to EMI noise at the handle wafer. Each plot illustrates the maximum EMI tolerance at a range of different frequency values of the EMI noise. At all tested frequencies, the peak to peak EMI tolerance is ˜3.6V.

FIG. 2H illustrates tolerance of the bandgap reference circuit to EMI noise at the reference node. Each plot illustrates the maximum EMI tolerance at a range of different frequency values of the EMI noise. At high frequencies, the peak to peak EMI tolerance at the reference voltage node is over 2V.

FIGS. 2F to 2H illustrate that the EMI/electromagnetic compatibility (EMC) behaviour is similar to conventional bandgap reference circuits.

The disclosed bandgap reference circuits 100 can provide a number of advantages over the conventional Banba architecture, including: the ability to generate a constant voltage, a constant current, a PTAT voltage, a PTAT current and a CTAT current (Banba only provides constant voltage and current), no OTA resulting in reduced flicker noise, lower noise performance more generally (see, e.g., FIG. 2C), lower consumption current (see, e.g., FIG. 2E), lower switch on voltage (1.3V), and lower area (fewer resistors).

No requirement for a buffer circuit for bandgap reference voltage, VBG. Conventional bandgap reference circuits typically require a buffer circuit on the output of the bandgap reference circuit to avoid the load affecting the bandgap reference voltage. The regulating loop of the example bandgap reference circuits can act as a buffer negating the need for a buffer circuit on the output.

While achieving the above advantages, the disclosed bandgap reference circuits can provide an EMI tolerance that is similar to conventional Banba designs and provide a sigma performance (VBG accuracy) that is similar to Banba performance.

The disclosed bandgap reference circuits provide a low power, low voltage, EMI tolerant Bandgap reference circuit that can generate a constant voltage and current.

The disclosure provides an EMC tolerant bandgap reference circuit suitable for systems where the bandgap reference needs to be ready at low voltage supply values and generate constant reference voltages and currents and consume low current.

The disclosed bandgap reference circuits can be particularly advantageous in automotive transceivers. For example, in the low power back bone in automotive transceivers such as 10 BASE-TIS and CAN XL.

The instructions and/or flowchart steps in the above figures can be executed in any order, unless a specific order is explicitly stated. Also, those skilled in the art will recognize that while one example set of instructions/method has been discussed, the material in this specification can be combined in a variety of ways to yield other examples as well and are to be understood within a context provided by this detailed description.

In some example embodiments the set of instructions/method steps described above are implemented as functional and software instructions embodied as a set of executable instructions which are effected on a computer or machine which is programmed with and controlled by said executable instructions. Such instructions are loaded for execution on a processor (such as one or more CPUs). The term processor includes microprocessors, microcontrollers, processor modules or subsystems (including one or more microprocessors or microcontrollers), or other control or computing devices. A processor can refer to a single component or to plural components.

In other examples, the set of instructions/methods illustrated herein and data and instructions associated therewith are stored in respective storage devices, which are implemented as one or more non-transient machine or computer-readable or computer-usable storage media or mediums. Such computer-readable or computer usable storage medium or media is (are) considered to be part of an article (or article of manufacture). An article or article of manufacture can refer to any manufactured single component or multiple components. The non-transient machine or computer usable media or mediums as defined herein excludes signals, but such media or mediums may be capable of receiving and processing information from signals and/or other transient mediums.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

In one example, one or more instructions or steps discussed herein are automated. The terms automated or automatically (and like variations thereof) mean controlled operation of an apparatus, system, and/or process using computers and/or mechanical/electrical devices without the necessity of human intervention, observation, effort and/or decision.

It will be appreciated that any components said to be coupled may be coupled or connected either directly or indirectly. In the case of indirect coupling, additional components may be located between the two components that are said to be coupled.

In this specification, example embodiments have been presented in terms of a selected set of details. However, a person of ordinary skill in the art would understand that many other example embodiments may be practiced which include a different selected set of these details. It is intended that the following claims cover all possible example embodiments.

1-15. (canceled)

16. A bandgap reference circuit comprising:
a proportional to absolute temperature (PTAT) voltage circuit configured to generate a PTAT voltage; and
a bandgap voltage circuit comprising a diode, the bandgap voltage circuit configured to:
receive the PTAT voltage from the PTAT voltage circuit; and
combine the PTAT voltage with a diode voltage across the diode to output a bandgap reference voltage.

17. The bandgap reference circuit of claim 16, wherein the bandgap voltage circuit comprises:
a bandgap voltage node configured to output the bandgap reference voltage; and
a tail voltage node configured to be set to the PTAT voltage,
wherein an anode of the diode is connected to the bandgap voltage node and a cathode of the diode is connected to the tail voltage node.

18. The bandgap reference circuit of claim 17, wherein the bandgap voltage circuit comprises:
a regulating transistor with a source terminal coupled to a supply voltage node and a drain terminal connected to the bandgap voltage node;
an input circuit coupled to the PTAT voltage circuit and configured to set the tail voltage node to the PTAT voltage; and
a current mirror output transistor with a conduction channel connected between the tail voltage node and a reference voltage node.

19. The bandgap reference circuit of claim 18, wherein the input circuit comprises:
a first input transistor, wherein a source terminal of the first input transistor is connected to the supply node and a drain terminal of the first input transistor is connected to a gate terminal of the regulating transistor; and
a second input transistor, wherein a drain terminal of the second input transistor is connected to the gate terminal of the regulating transistor and a source terminal of the second input transistor is connected to the tail voltage node.

20. The bandgap reference circuit of claim 19, wherein the regulating transistor, the diode and the first and second input transistors form a regulation loop configured to regulate a current through the regulating transistor to regulate the bandgap reference voltage at the bandgap voltage node.

21. The bandgap reference circuit of claim 17, wherein the bandgap reference circuit comprises an output circuit connected between the bandgap voltage node and a reference node, wherein the output circuit is configured to provide a constant current through the output circuit from the bandgap voltage node to the reference node.

22. The bandgap reference circuit of claim 21, wherein the output circuit comprises an output resistance circuit.

23. The bandgap reference circuit of claim 21, wherein the output circuit comprises a current sink.

24. The bandgap reference circuit of claim 21, wherein the bandgap voltage circuit comprises:
a regulating transistor with a source terminal coupled to a supply voltage node and a drain terminal connected to the bandgap voltage node;
an input circuit coupled to the PTAT voltage circuit and configured to set the tail voltage node to the PTAT voltage; and
a current mirror output transistor with a conduction channel connected between the tail voltage node and a reference voltage node,
wherein the current mirror output transistor is configured to pull a constant current through the regulating transistor that is equal to the constant current provided through the output circuit.

25. The bandgap reference circuit of claim 24, wherein the current mirror output transistor is configured to mirror a multiple of a PTAT current from the PTAT voltage circuit to provide the constant current through the regulating transistor.

26. The bandgap reference circuit of claim 24, wherein the bandgap reference circuit comprises an output current reference transistor configured to mirror the constant current from the regulating transistor to a constant current output terminal.

27. The bandgap reference circuit of claim 24, wherein the bandgap reference circuit comprise a balancing current transistor, wherein:
a source terminal of the balancing current transistor is connected to the supply voltage node; and
a drain terminal of the balancing current transistor is connected to the bandgap voltage node.

28. The bandgap reference circuit of claim 27, wherein the balancing current transistor is configured to mirror a PTAT current from the PTAT voltage circuit.

29. The bandgap reference circuit of claim 27, wherein a gate terminal of the balancing current transistor is coupled to the PTAT voltage circuit.

30. The bandgap reference circuit of claim 27, wherein the bandgap voltage circuit comprises:
a regulating transistor with a source terminal coupled to a supply voltage node and a drain terminal connected to the bandgap voltage node;
an input circuit coupled to the PTAT voltage circuit and configured to set the tail voltage node to the PTAT voltage; and
a current mirror output transistor with a conduction channel connected between the tail voltage node and a reference voltage node,
wherein:
the input circuit is configured to mirror a first PTAT current from the PTAT voltage circuit;
the balancing current transistor is configured to mirror a second PTAT current from the PTAT voltage circuit; and
the current mirror output transistor is configured to mirror a third PTAT current from the PTAT voltage circuit equal to a sum of the first PTAT current and the second PTAT current.

31. The bandgap reference circuit of claim 30, wherein the first PTAT current equals the second PTAT current.

32. The bandgap reference circuit of claim 30, wherein the balancing current transistor is configured to mirror the second PTAT current by mirroring the first PTAT current from the input circuit.

33. The bandgap reference circuit of claim 16, wherein the PTAT voltage circuit comprises:
a PTAT core comprising a first resistor and configured to generate a PTAT current through the first resistor; and
an intermediate current mirror branch comprising a second resistor and configured to mirror the PTAT current from the PTAT core through the second resistor to generate the PTAT voltage.

34. The bandgap reference circuit of claim 33, wherein a resistance of the second resistor is greater than a resistance of the first resistor.

35. An automotive transceiver comprising the bandgap reference circuit of claim 16.
